(19) United States
(12) Patent Application Publication
(10) Pub. No.: US 2024/0038995 A1
(43) Pub. Date: Feb. 1, 2024

(54) ELECTROCHEMICAL APPARATUS AND ELECTRONIC APPARATUS

(71) Applicant: Ningde Amperex Technology Limited, Ningde (CN)

(72) Inventor: Xiaohu CAI, Ningde (CN)

(73) Assignee: Ningde Amperex Technology Limited, Ningde (CN)

(21) Appl. No.: 18/478,154

(22) Filed: Sep. 29, 2023

Related U.S. Application Data
(63) Continuation of application No. PCT/CN2021/084051, filed on Mar. 30, 2021.

(51) Int. Cl. H01M 4/62; G01N 23/2055

(52) U.S. Cl. CPC H01M 4/623; G01N 23/2055; H01M 2004/028

(57) ABSTRACT

An electrochemical apparatus includes a positive electrode, the positive electrode includes a current collector and a positive electrode mixture layer disposed on at least one surface of the current collector. The positive electrode mixture layer includes a positive electrode active substance and a binder. The binder includes a fluorine-containing polymer. In an XRD diffraction pattern of the fluorine-containing polymer, a diffraction peak A appears at 25° to 27° and corresponds to a (111) crystal plane, and a diffraction peak B appears at 37° to 39° and corresponds to a (022) crystal plane, where an area ratio of the diffraction peak A to the diffraction peak B satisfies 1≤A(111)/B(022)≤4.

### CROSS REFERENCE TO THE RELATED APPLICATIONS

This application is a continuation under 35 U.S.C. § 120 of international patent application PCT/CN2021/084051 filed on Mar. 30, 2021, the entire content of which is incorporated herein by reference.

### TECHNICAL FIELD

This application relates to the field of electrochemical technologies, and specifically, to an electrochemical apparatus and an electronic apparatus.

### BACKGROUND

Lithium-ion batteries have been widely used in the fields such as electric energy storage, portable electronic devices, and electric vehicles, by virtue of their characteristics such as high specific energy, high working voltage, low self-discharge rate, small size, and light weight.

With the development of the field of lithium-ion batteries, people have increasingly high requirements for kinetic performance and energy density of the lithium-ion batteries. One method for increasing energy density of a lithium-ion battery is to increase compacted density of a positive electrode plate. However, when the compacted density is relatively high (for example, higher than 3.0 g/mm³), the positive electrode plate has the problem of brittle fracture during folding, which causes fracture of electrode plates inside a lithium-ion battery with a winding structure, resulting in performance loss of the lithium-ion battery. Therefore, there is an urgent need to improve flexibility of the positive electrode plate while increasing the compacted density of the positive electrode plate, so as to avoid the problem of brittle fracture.

### SUMMARY

This application is intended to provide an electrochemical apparatus and an electronic apparatus, so as to improve flexibility of a positive electrode with high compacted density, thereby improving anti-swelling performance and cycling performance of the electrochemical apparatus. Specific technical solutions are as follows.

It should be noted that in the content of this application, an example in which a lithium-ion battery is used as an electrochemical apparatus is used to illustrate this application. However, the electrochemical apparatus of this application is not limited to the lithium-ion battery.

A first aspect of this application provides an electrochemical apparatus including a positive electrode, where the positive electrode includes a current collector and a positive electrode mixture layer disposed on at least one surface of the current collector, and the positive electrode mixture layer includes a positive electrode active substance and a binder. The binder includes a fluorine-containing polymer, and in an XRD diffraction pattern of the fluorine-containing polymer, a diffraction peak A appears at 25° to 27° and corresponds to a (111) crystal plane, and a diffraction peak B appears at 37° to 39° and corresponds to a (022) crystal plane, where an area ratio of the diffraction peak A to the diffraction peak B satisfies 1≤A(111)/B(022)≤4.

Without being bound by any theory, in the fluorine-containing polymer in this application, when the area ratio of the diffraction peak A to the diffraction peak B satisfies 1≤A(111)/B(022)≤4, the positive electrode can have high flexibility, so that the positive electrode in this application has high flexibility and compacted density.

The positive electrode mixture layer in this application may be disposed on at least one surface of the current collector. For example, the positive electrode mixture layer may be disposed on one surface of the current collector, or the positive electrode mixture layer may be disposed on two surfaces of the current collector. In this application, the positive electrode may specifically be a positive electrode plate, and a negative electrode may specifically be a negative electrode plate.

In an embodiment of this application, in the XRD diffraction pattern of the fluorine-containing polymer, a diffraction peak C appears at 42° to 43° and corresponds to a (131) crystal plane. When the fluorine-containing polymer in this application has the diffraction peak C at 42° to 43°, the flexibility of the positive electrode can be further improved.

In an embodiment of this application, a weight-average molecular weight of the binder is 800000 to 1100000. Without being bound by any theory, when the weight-average molecular weight of the binder is excessively low (for example, lower than 800000), the binder is soft, resulting in a decreased softening point of the binder, which is not conducive to enhancing adhesion of the binder. When the weight-average molecular weight of the binder is excessively high (for example, higher than 1100000), the softening point of the binder is excessively high, which is not conducive to processing and affects enhancement of the adhesion of the binder. With the weight-average molecular weight of the binder in this application controlled within the foregoing range, a binder with good adhesion can be obtained, thereby improving cycling stability of the lithium-ion battery.

In an embodiment of this application, a molecular weight distribution of the binder satisfies 2.05≤Mw/Mn≤3.6, where Mn represents number-average molecular weight, and Mw represents weight-average molecular weight. Without being bound by any theory, when Mw/Mn is excessively large (for example, greater than 3.6), it indicates that the molecular weight distribution of the binder is wide. Specifically, a molecular weight of a macromolecular binder is excessively large and a molecular weight of a small-molecule binder is excessively small, and the macromolecular binder is not easily melted after heating and the small-molecule binder easily agglomerates in a slurry. When Mw/Mn is excessively small (for example, less than 2.05), the molecular weight distribution is narrow. During cold pressing, adhesion of the binder leads to large inter-particle forces in the positive electrode mixture layer, which prevents effective slip, and severely damages the current collector under high compacted density, resulting in brittle fracture of the positive electrode. The inventors have unexpectedly found that combining the foregoing fluorine-containing polymer having a specific crystalline type and molecular weight distribution with the positive electrode active substance can further improve the flexibility of the positive electrode. This may be because during cold pressing, chain segments of the binder are more prone to move between positive electrode active substance particles and a conductive agent, so the positive electrode active substance particles are subjected to small force, resulting in slight damage to the current collector, thereby improving the flexibility of the positive electrode.

Monomers forming the fluorine-containing polymer are not particularly limited in this application, provided that the requirements of this application can be met. In an embodiment of this application, the fluorine-containing polymer includes at least one of homopolymers or copolymers of vinylidene fluoride, hexafluoropropylene, pentafluoropropylene, tetrafluoropropylene, trifluoropropylene, perfluorobutene, hexafluorobutadiene, hexafluoroisobutylene, trifluoroethylene, trifluorochloroethylene, and tetrafluoroethylene.

In an embodiment of this application, compacted density of the positive electrode mixture layer is 3.0 g/mm³ to 4.5 g/mm³, and preferably 4.1 g/mm³ to 4.4 g/mm³. Without being bound by any theory, when the compacted density of the positive electrode mixture layer is excessively low (for example, lower than 3.0 g/mm³), it is not conducive to increasing energy density of the lithium-ion battery. When the compacted density of the positive electrode mixture layer is excessively high (for example, higher than 4.5 g/mm³), the positive electrode is more prone to experience brittle fracture, which is not conducive to improving the flexibility of the positive electrode. The compacted density of the positive electrode mixture layer being controlled within the foregoing range can further increase the energy density of the lithium-ion battery and improve the flexibility of the positive electrode.

In an embodiment of this application, an adhesion force between the positive electrode mixture layer and the current collector is 15 N/m to 35 N/m, and preferably 18 N/m to 25 N/m. Without being bound by any theory, when the adhesion force between the positive electrode mixture layer and the current collector is excessively low (for example, lower than 15 N/m), it is not conducive to improving the structural stability and flexibility of the positive electrode. When the adhesion force between the positive electrode mixture layer and the current collector is excessively high (for example, higher than 35 N/m), more binder is required, which is not conducive to increasing the energy density of the lithium-ion battery. The adhesion force between the positive electrode mixture layer and the current collector in this application being controlled within the foregoing range can further improve the flexibility of the positive electrode and increase the energy density of the lithium-ion battery.

In an embodiment of this application, Dᵥ50 of the positive electrode active substance is 0.5 μm to 35 μm, preferably 5 μm to 30 μm, and more preferably 10 μm to μm. Without being bound by any theory, when Dᵥ50 of the positive electrode active substance is excessively small (for example, less than 0.5 μm), the positive electrode active substance particles and the binder and conductive agent particles in the positive electrode mixture layer are poorly packed, and the compacted density of the positive electrode mixture layer is decreased, so a cold pressing pressure needs to be increased to increase the compacted density, whereas this further increases brittleness of the positive electrode. When Dᵥ50 of the positive electrode active substance is excessively large (for example, greater than 35 μm), due to the large particle size of the positive electrode active substance particles and numerous edges and corners of the particles, the degree of damage to the current collector is increased during cold pressing, which also results in high brittleness of the positive electrode under high compacted density. Dᵥ50 of the positive electrode active substance in this application being controlled within the foregoing range can further increase the compacted density of the positive electrode mixture layer and improve the flexibility of the positive electrode.

Dᵥ50 is a particle size where the cumulative distribution by volume reaches 50% as counted from the small particle size side.

In an embodiment of this application, thickness of the current collector is 7 μm to 20 μm, and preferably 8 μm to 12 μm. Without being limited to any theory, when the thickness of the current collector is excessively small (for example, less than 7 μm), it is not conducive to improving strength of the positive electrode. When the thickness of the current collector is excessively large (for example, greater than 20 μm), it is not conducive to increasing the energy density of the lithium-ion battery. The thickness of the current collector of the positive electrode being controlled within the foregoing range can further improve the strength of the positive electrode and increase the energy density of the lithium-ion battery.

In an embodiment of this application, single-sided thickness of the positive electrode mixture layer is 40.5 μm to 55 μm. Without being limited to any theory, when the thickness of the positive electrode mixture layer is excessively small (for example, less than 40.5 μm), the active substance particles in the positive electrode mixture layer are prone to breakage during cold pressing, which affects the cycling performance of the lithium-ion battery. When the thickness of the positive electrode mixture layer is excessively large (for example, greater than 55 μm), the positive electrode plate is more prone to stress concentration during folding, resulting in brittle fracture. The single-sided thickness of the positive electrode mixture layer in this application being controlled within the foregoing range can further improve the flexibility of the positive electrode and increase the compacted density of the positive electrode mixture layer, thereby improving the performance of the lithium-ion battery.

Percentage of the binder in the positive electrode mixture layer is not particularly limited in this application, provided that the requirements of this application are met. In an embodiment, mass percentage of the binder in the positive electrode mixture layer is 1% to 5%.

The preparation method of the binder in this application is not particularly limited and can be a preparation method from persons skilled in the art. For example, the following preparation method can be used.

After a reactor is evacuated and nitrogen is pumped to replace oxygen, deionized water, sodium perfluorooctanoate solution with a mass concentration of about 5%, and paraffin wax (with a melting point of 60° C.) are put into the reactor, with a stirring speed adjusted to 120 rpm/min to 150 rpm/min and temperature of the reactor raised to about 90° C., and then monomers (for example, vinylidene fluoride) are added to reach a reactor pressure of 5.0 MPa. An initiator is added to start a polymerization reaction, and the vinylidene fluoride monomers are added to maintain the reactor pressure at 5.0 MPa. 0.005 g to 0.01 g of initiator is added in batches about every 10 min, and a chain transfer agent is added in four batches at conversion rates of 20%, 40%, 60%, and 80%, respectively, with 3 g to 6 g added each time. The reaction continues until the pressure drops to 4.0 MPa, and then degassing and material collecting are performed. The reaction time is 2 hours to 3 hours.

The initiator is not particularly limited in this application, provided that monomer polymerization can be triggered. For example, the initiator may be dioctyl peroxydicarbonate or phenoxyethyl peroxydicarbonate. Amounts of the deionized water, the initiator, and the chain transfer agent added are not particularly limited in this application, provided that the monomers added can undergo polymerization reaction.

The positive electrode current collector of the positive electrode in this application is not particularly limited and can be any positive electrode current collector in the art, for example, aluminum foil, aluminum alloy foil, or a composite current collector. A positive electrode active substance layer includes a positive electrode active substance and a conductive agent. The positive electrode active substance is not particularly limited and can be any positive electrode active substance in the art. For example, the positive electrode active substance may include at least one of lithium nickel cobalt manganate (811, 622, 523, 111), lithium nickel cobalt aluminate, lithium iron phosphate, lithium-rich manganese-based material, lithium cobalt oxide, lithium manganate, lithium manganese iron phosphate, or lithium titanate. The conductive agent is not particularly limited, provided that the objectives of this application can be achieved. For example, the conductive agent may include at least one of conductive carbon black (Super P), carbon nanotubes (CNTs), carbon nanofiber, flake graphite, acetylene black, carbon black, Ketjen black, carbon dots, or graphene.

The negative electrode plate in this application is not particularly limited, provided that the objectives of this application can be achieved. For example, the negative electrode plate generally includes a negative electrode current collector and a negative electrode active substance layer. The negative electrode current collector is not particularly limited, and can be any negative electrode current collector in the art, for example, copper foil, aluminum foil, aluminum alloy foil, or a composite current collector. The negative electrode active substance layer includes a negative electrode active substance. The negative electrode active substance is not particularly limited, and can be any negative electrode active substance in the art. For example, the negative electrode active substance may include at least one of artificial graphite, natural graphite, meso-carbon microbeads, soft carbon, hard carbon, silicon, silicon carbon, or lithium titanate.

A separator in this application includes but is not limited to at least one of polyethylene, polypropylene, polyethylene glycol terephthalate, polyimide, or aramid. For example, polyethylene includes at least one component selected from high-density polyethylene, low-density polyethylene, and ultra-high-molecular-weight polyethylene. Particularly, polyethylene and polypropylene can well prevent short circuit, and can improve stability of the lithium-ion battery through a shutdown effect.

A surface of the separator may further include a porous layer. The porous layer is disposed on at least one surface of the separator, and the porous layer includes inorganic particles and a binder. The inorganic particles are selected from a combination of one or more of aluminum oxide (Al₂O₃), silicon oxide (SiO₂), magnesium oxide (MgO), titanium oxide (TiO₂), hafnium dioxide (HfO₂), tin oxide (SnO₂), ceria oxide (CeO₂), nickel oxide (NiO), zinc oxide (ZnO), calcium oxide (CaO), zirconium oxide (ZrO₂), yttrium oxide (Y₂O₃), silicon carbide (SiC), boehmite, aluminum hydroxide, magnesium hydroxide, calcium hydroxide, and barium sulfate. The binder is selected from a combination of one or more of polyvinylidene fluoride, vinylidene fluoride-hexafluoropropylene copolymer, polyamide, polyacrylonitrile, polyacrylate ester, polyacrylic acid, polyacrylate salt, sodium carboxymethyl cellulose, polyvinylpyrrolidone, polyvinyl ether, polymethyl methacrylate, polytetrafluoroethylene, and polyhexafluoropropylene.

The porous layer can improve heat resistance, oxidation resistance, and electrolyte infiltration performance of the separator, and enhance adhesion between the separator and the positive electrode or the negative electrode.

The lithium-ion battery in this application further includes an electrolyte. The electrolyte may be one or more of a gel electrolyte, a solid electrolyte, and an electrolyte solution. The electrolyte solution includes a lithium salt and a non-aqueous solvent.

In some embodiments of this application, the lithium salt is selected from one or more of LiPF₆, LiBF₄, LiAsF₆, LiClO₄, LiB(C₆H₅)₄, LiCH₃SO₃, LiCF₃SO₃, LiN(SO₂CF₃)₂, LiC(SO₂CF₃)₃, LiSiF₆, LiBOB, and lithium difluoroborate. For example, LiPF₆ may be selected as the lithium salt because it can provide high ionic conductivity and improve cycling characteristics.

The non-aqueous solvent may be a carbonate compound, a carboxylate compound, an ether compound, another organic solvent, or a combination thereof.

The carbonate compound may be a linear carbonate compound, a cyclic carbonate compound, a fluorocarbonate compound, or a combination thereof.

An example of the linear carbonate compound is dimethyl carbonate (DMC), diethyl carbonate (DEC), dipropyl carbonate (DPC), methyl propyl carbonate (MPC), ethyl propyl carbonate (EPC), ethyl methyl carbonate (MEC), or a combination thereof. An example of the cyclic carbonate compound is ethylene carbonate (EC), propylene carbonate (PC), butylene carbonate (BC), vinyl ethylene carbonate (VEC), or a combination thereof. An example of the fluorocarbonate compound is fluoroethylene carbonate (FEC), 1,2-difluoroethylene carbonate, 1,1-difluoroethylene carbonate, 1,1,2-trifluoroethylene carbonate, 1,1,2,2-tetrafluoroethylene carbonate, 1-fluoro-2-methylethylene carbonate, 1-fluoro-1-methylethylene carbonate, 1,2-difluoro-1-methylethylene carbonate, 1,1,2-trifluoro-2-methylethylene carbonate, trifluoromethylethylene carbonate, or a combination thereof.

An example of the carboxylate compound is methyl formate, methyl acetate, ethyl acetate, n-propyl acetate, tert-butyl acetate, methyl propionate, ethyl propionate, propyl propionate, γ-butyrolactone, decanolide, valerolactone, mevalonolactone, caprolactone, or a combination thereof.

An example of the ether compound is dibutyl ether, tetraglyme, diglyme, 1,2-dimethoxyethane, 1,2-diethoxyethane, ethoxymethoxyethane, 2-methyltetrahydrofuran, tetrahydrofuran, or a combination thereof.

An example of the another organic solvent is dimethyl sulfoxide, 1,2-dioxolane, sulfolane, methyl sulfolane, 1,3-dimethyl-2-imidazolidinone, N-methyl-2-pyrrolidone, formamide, dimethylformamide, acetonitrile, trimethyl phosphate, triethyl phosphate, trioctyl phosphate, phosphate ester, or a combination thereof.

A second aspect of this application provides an electrochemical apparatus including the positive electrode according to the first aspect.

A third aspect of this application provides an electronic apparatus including the electrochemical apparatus according to the second aspect.

The electronic apparatus of this application is not particularly limited and can be any known electronic apparatus used in the prior art. In some embodiments, the electronic apparatus may include but is not limited to a notebook computer, a pen-input computer, a mobile computer, an electronic book player, a portable telephone, a portable fax machine, a portable copier, a portable printer, a stereo headset, a video recorder, a liquid crystal television, a portable cleaner, a portable CD player, a mini-disc, a transceiver, an electronic notebook, a calculator, a storage card, a portable recorder, a radio, a standby power source, a motor, an automobile, a motorcycle, a motor bicycle, a bicycle, a lighting appliance, a toy, a game console, a clock, an electric tool, a flash lamp, a camera, a large household battery, or a lithium-ion capacitor.

The preparation process of the electrochemical apparatus is well known to persons skilled in the art, and is not particularly limited in this application. For example, the electrochemical apparatus may be manufactured in the following process: a positive electrode and a negative electrode are stacked with a separator therebetween, and are put into a housing after operations such as winding and folding as needed. An electrolyte is injected into the housing and then the housing is sealed. In addition, an overcurrent prevention element, a guide plate, and the like may also be placed into the housing as needed, so as to prevent pressure increase, overcharge, and overdischarge inside the electrochemical apparatus.

This application provides an electrochemical apparatus and an electronic apparatus. The electrochemical apparatus includes a positive electrode, where a positive electrode mixture layer of the positive electrode includes a positive electrode active substance and a binder. The binder includes a fluorine-containing polymer, and in an XRD diffraction pattern of the fluorine-containing polymer, a diffraction peak A appears at 25° to 27° and corresponds to a (111) crystal plane, and a diffraction peak B appears at 37° to 39° and corresponds to a (022) crystal plane, where an area ratio of the diffraction peak A to the diffraction peak B satisfies 1≤A(111)/B(022)≤4. Therefore, the positive electrode in this application has high flexibility and compacted density, thereby alleviating the problem of brittle fracture of the positive electrode, and improving anti-swelling performance and cycling performance of the lithium-ion battery.

### BRIEF DESCRIPTION OF DRAWINGS

To describe the technical solutions in this application and the prior art more clearly, the following briefly describes the accompanying drawings required for describing embodiments and the prior art. Apparently, the accompanying drawings in the following description show merely some embodiments of this application.

FIG. 1 is an XRD diffraction pattern of a binder in Example 2 of this application; and

FIG. 2 is an XRD diffraction pattern of a binder in Example 4 of this application.

### DETAILED DESCRIPTION

To make the objectives, technical solutions, and advantages of this application more comprehensible, the following further describes this application in detail with reference to accompanying drawings and embodiments. Apparently, the described embodiments are only some but not all of the embodiments of this application. All other embodiments obtained by persons of ordinary skill in the art based on this application shall fall within the protection scope of this application.

It should be noted that in specific embodiments of this application, an example in which a lithium-ion battery is used as an electrochemical apparatus is used to illustrate this application. However, the electrochemical apparatus of this application is not limited to the lithium-ion battery.

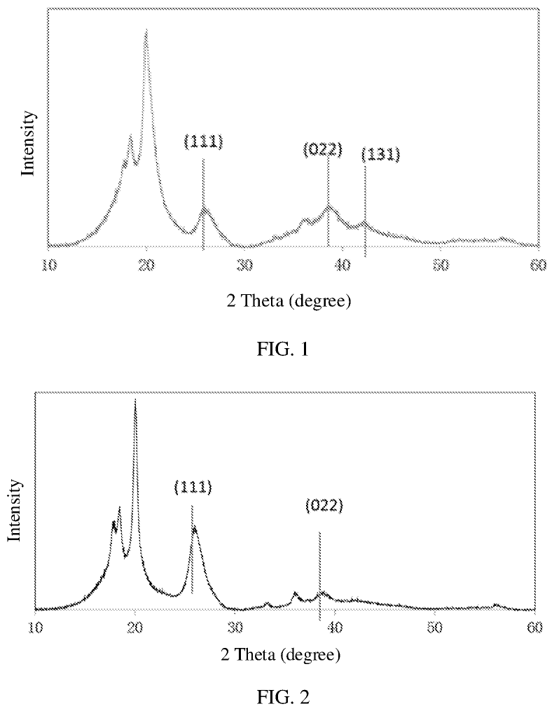

As shown in FIG. 1, in an XRD diffraction pattern of a binder in Example 2 of this application, a diffraction peak A appears at 25° to 27° and corresponds to a (111) crystal plane, a diffraction peak B appears at 37° to 39° and corresponds to a (022) crystal plane, and a diffraction peak C appears at 42° to 43° and corresponds to a (131) crystal plane.

As shown in FIG. 2, in an XRD diffraction pattern of a binder in Comparative Example 4 of this application, a diffraction peak A appears at 25° to 27° and corresponds to a (111) crystal plane, and a diffraction peak B appears at 37° to 39° and corresponds to a (022) crystal plane, where A(111)/B(022)=5.05.

### EXAMPLES

The following describes some embodiments of this application more specifically by using examples and comparative examples. Various tests and evaluations are performed according to the following methods. In addition, unless otherwise specified, “part” and “%” are based on weight.

Test Methods and Equipment

XRD Test

1.0 g of binder sample prepared in each example and comparative example was taken and put into a recess of a glass sample holder, compressed and smoothed with a glass sheet, and tested with an X-ray diffractometer (model: Bruker, D8) according to JJS K 0131-1996 General Rules for X-ray Diffraction Analysis to obtain an XRD diffraction pattern of the binder, where the test voltage was set to 40 kV, current to 30 mA, scanning angle to a range of 10° to 90°, and scanning step to 0.0167°, with a time set for each scanning step being 0.24 s.

Adhesion Force Test

(1) A discharged lithium-ion battery under test was disassembled, and then a positive electrode plate was taken out. The positive electrode plate was soaked in DMO (dimethyl oxalate) for 30 min to remove electrolyte and by-products on the surface of the positive electrode plate, and then dried in a fume hood at 25° C. for 4 hours. The dried positive electrode plate was taken out and then cut into a sample being 30 mm wide and 100 mm long with a blade.

(2) A double-sided tape being 20 mm wide and 90 mm long was pasted to a steel plate.

(3) The sample obtained by cutting in step (1) was pasted to the double-sided tape, with the test surface facing downward to be attached to the double-sided tape.

(4) A paper tape with the same width as the sample and a length of 80 mm greater than that of the sample was inserted below the sample and fastened with a wrinkle stipple.

(5) A tensile machine (brand: Sunstest, and model: Instron 3365) was powered on, and after an indicator lit, a restraint block was adjusted to an appropriate position.

(6) The sample prepared in (4) was fastened on a test bench, and the paper tape was folded upward and fastened with clamps. The paper tape was pulled at a speed of 10 mm/min and within a test range of 0 mm to 40 mm at 90°, so that a positive electrode mixture layer and a current collector that were attached to the surface of the double-sided tape were pulled apart until the end of the test.

(7) The test data was saved according to software prompts, to obtain adhesion force data between the positive electrode mixture layer and the current collector. After the test was completed, the sample was taken out, and the instrument was turned off.

Brittle Fracture Test of Electrode Plate

At 25° C. and 40% RH (relative humidity), the cold-pressed positive electrode plate prepared in each example and comparative example was dried in the fume hood for 4 hours, and then the dried positive electrode plate was taken out. Then, the positive electrode plate was cut into a sample of 4 cm×25 cm. The sample was pre-folded along its longitudinal direction, the pre-folded test film was placed on the platform of the test bench, and a 2 kg cylinder was used to roll the pre-folded sample twice in the same direction. The sample was folded back along the longitudinal crease, and the electrode plate was unfolded and observed against the light. If the folded electrode plate fractured or the light transmission parts formed a line, the result was defined as severe. If the folded electrode plate showed scattered light transmission, the result was defined as slight. If the folded electrode plate had no light transmission or fracture, the result was defined as none.

Ultimate Compacted Density Test of Positive Electrode Mixture Layer

Compacted density of positive electrode mixture layer=mass of positive electrode active substance layer per unit area (g/mm²)/thickness of positive electrode mixture layer (mm). A discharged lithium-ion battery under test was disassembled, and then a positive electrode plate was taken out. The positive electrode plate was soaked in DMO (dimethyl oxalate) for 30 min to remove electrolyte and by-products on the surface of the positive electrode plate, and then dried in the fume hood for 4 hours. The dried positive electrode plate was taken out, and the thickness of the positive electrode mixture layer in the positive electrode plate was measured with a ten-thousandths micrometer. Then, the positive electrode active substance layer per unit area in the positive electrode plate was scraped with a scraper, the mass of the positive electrode active substance layer per unit area in the positive electrode plate was weighed with a balance, and the compacted density of the positive electrode mixture layer was calculated according to the foregoing formula.

The ultimate compacted density of the positive electrode mixture layer is a corresponding compacted density of the positive electrode mixture layer when the positive electrode is subjected to the maximum press amount (corresponding to the maximum equipment pressure and the minimum roller gap).

Measurement of Weight-Average Molecular Weight and Number-Average Molecular Weight of Binder

Molecular weight and molecular weight distribution were tested using an advanced polymer chromatography (ACQUITY APC) and a detector (ACQUITY refractive index detector) with reference to GB/T 21863-2008 Gel Permeation Chromatography. The test steps were as follows: (1) Power on and warm up: the chromatographic column and pipeline were installed, the console, test power supply, and the like were turned on in sequence, and then the test software Empower was opened. (2) Parameter setting and sample volume: 0 μL to 50 μL (depending on the sample concentration); pump flow rate: 0.2 mL/min; mobile phase: NMP solution with 30 mol/L LiBr; sealing cleaning solution: isopropanol; precolumn: PL gel 10 um MiniMIX-B Guard (size: 50 mm×4.6 mm×2); analytical phase: PL gel 10 um MiniMIX-B (size: 250 mm×4.6 mm); standard sample: polystyrene standards; running time: 30 min; detector: ACQUITY refractive index (RI) detector; column oven temperature: 90° C.; and detector temperature: 55° C. (3) Sample test: a. standard sample and test sample preparation: 0.002 g to 0.004 g standard sample/test sample were weighed and added to 2 mL mobile phase liquid to prepare 0.1% to 0.5% mixed standard sample, and then the sample was placed in a refrigerator for more than 8 h; and b. standard liquid/sample test: the sample group under test was edited, the established sample group method was selected, and after the baseline stabilized, the run queue was clicked on to start testing the sample. (4) Data processing: a calibration curve was established using a chemical workstation according to the relationship between retention time and molecular weight, quantitative integration was performed on the sample chromatogram, and the chemical workstation automatically generated molecular weight and molecular weight distribution results.

Test of Dᵥ50 and Dᵥ10 of Positive Electrode Active Substance

Dᵥ50 of the positive electrode active substance was tested using a laser particle size analyzer.

Capacity Retention Rate Test:

At a test environment temperature of 25° C., the lithium-ion battery after formation was charged to a cut-off voltage of 4.45 V at a current of 0.7 C in a constant-current charging phase, and then charged to a cut-off current of 0.05 C at a constant voltage to stop the charging. After fully charged, the battery was left standing for 5 min, and then discharged to 3.0 V at a current of 0.5 C. This was one charge and discharge cycle. After 500 such charge and discharge cycles were conducted, a discharge capacity of the 500th cycle was divided by a discharge capacity of the first cycle to obtain the cycling capacity retention rate.

Thickness Swelling Test of Lithium-Ion Battery

Thickness of the lithium-ion battery was tested using a PPG plate thickness gauge. Thickness swelling rate of lithium-ion battery=(fully charged thickness after cycling−first fully charged thickness)/first fully charged thickness×100%.

### Example 1

<1-1. Preparation of Positive Electrode Plate>

<1-1-1. Preparation of Binder>

After a reactor with a volume of 25 L was evacuated and nitrogen was pumped to replace oxygen, 18 kg deionized water, 200 g sodium perfluorooctanoate solution with a mass concentration of 5%, and 80 g of paraffin wax (with a melting point of 60° C.) were put into the reactor, with a stirring speed adjusted to 130 rpm/min and temperature of the reactor raised to 85° C., and then vinylidene fluoride monomers were added to reach a reactor pressure of 5.0 MPa. 1.15 g of initiator dioctyl peroxydicarbonate was added to start a polymerization reaction. Then, the vinylidene fluoride monomers were added to maintain the reactor pressure at 5.0 MPa. 0.01 g of initiator was added in batches every 10 min, and a chain transfer agent HFC-4310 was added in four batches at conversion rates of 20%, 40%, 60%, and 80%, respectively, with 5 g added each time. A total of 5 kg vinylidene fluoride monomers were added for the reaction. The reaction continued until the pressure dropped to 4.0 MPa, and then degassing and material collecting were performed. The reaction time was 2 hours and 20 minutes. After centrifugation, washing, and drying, the binder PVDF was obtained. The PVDF had a weight-average molecular weight of 900000 and a molecular weight distribution of Mw/Mn=2.15. The binder had a diffraction peak A at 26.2°, a diffraction peak B at 38.5°, and a diffraction peak C at 42.2°, and an area ratio of the diffraction peak A to the diffraction peak B satisfied A(111)/B(022)=1.0.

<1-1-2. Preparation of Positive Electrode Plate Containing Binder>

Positive electrode active substance lithium cobalt oxide (with Dᵥ50 of 15.6 μm), acetylene black, and the prepared binder were mixed at a mass ratio of 96:2:2, then NMP was added as a solvent to obtain a slurry with a solid content of 75%, and the slurry was stirred to uniformity. The slurry was uniformly applied onto one surface of a 9 μm thick aluminum foil and dried at 90° C., followed by cold pressing, to obtain a positive electrode plate with a 46 μm thick positive electrode mixture layer. Then, the same steps were repeated on the other surface of the positive electrode plate to obtain a positive electrode plate coated with positive electrode active substance layers on two surfaces. The positive electrode plate was cut into a size of 74 mm×867 mm and then welded with tabs for use.

<1-2. Preparation of Negative Electrode Plate>

Negative electrode active substance artificial graphite, styrene-butadiene rubber, and sodium carboxymethyl cellulose were mixed at a mass ratio of 96:2:2, then deionized water was added as a solvent to obtain a slurry with a solid content of 70%, and the slurry was stirred to uniformity. The slurry was uniformly applied onto one surface of an 8 μm thick copper foil and dried at 110° C., followed by cold pressing, to obtain a negative electrode plate with a 50 μm thick negative electrode mixture layer and one surface coated with a negative electrode active substance layer. Then, the same coating steps were repeated on the other surface of the negative electrode plate to obtain a negative electrode plate coated with negative electrode active substance layers on two surfaces. The negative electrode plate was cut into a size of 74 mm×867 mm and then welded with tabs for use.

<1-3. Preparation of Separator>

A 15 μm thick polyethylene (PE) porous polymer film was used as a separator.

<1-4. Preparation of Electrolyte>

In an environment with a water content less than 10 ppm, non-aqueous organic solvents ethylene carbonate (EC), propylene carbonate (PC), and diethyl carbonate (DEC) were mixed at a mass ratio of 1:1:1, and then lithium hexafluorophosphate (LiPF₆) was added to the non-aqueous organic solvents for dissolving and mixing to uniformity, to obtain an electrolyte, where a concentration of LiPF₆ was 1.15 mol/L.

<1-5. Preparation of Lithium-Ion Battery>

The prepared positive electrode plate, separator, and negative electrode plate were stacked in sequence, so that the separator was sandwiched between the positive electrode plate and the negative electrode plate for separation. Then the resulting stack was wound to obtain an electrode assembly. The electrode assembly was placed into an aluminum-plastic packaging bag and dehydrated at 80° C., and the prepared electrolyte was injected, followed by processes such as vacuum sealing, standing, formation, and shaping, to obtain a lithium-ion battery.

### Example 2

Example 2 was the same as Example 1 except that in <Preparation of binder>, the reaction temperature was adjusted to 88° C., such that the area ratio of the diffraction peak A to the diffraction peak B of the binder satisfied A(111)/B(022)=1.5.

### Example 3

Example 3 was the same as Example 1 except that in <Preparation of binder>, the reaction temperature was adjusted to 92° C., such that the area ratio of the diffraction peak A to the diffraction peak B of the binder satisfied A(111)/B(022)=2.4.

### Example 4

Example 4 was the same as Example 1 except that in <Preparation of binder>, phenoxyethyl peroxydicarbonate was used as the initiator, such that the area ratio of the diffraction peak A to the diffraction peak B of the binder satisfied A(111)/B(022)=3.2.

### Example 5

Example 5 was the same as Example 1 except that in <Preparation of binder>, phenoxyethyl peroxydicarbonate was used as the initiator and the reaction temperature was adjusted to 90° C., such that the area ratio of the diffraction peak A to the diffraction peak B of the binder satisfied A(111)/B(022)=3.9.

### Example 6

Example 6 was the same as Example 1 except that in <Preparation of binder>, the binder PVDF was replaced with the copolymer formed by 95% VDF and 5% hexafluoropropylene.

### Example 7

Example 7 was the same as Example 1 except that in <Preparation of binder>, the binder PVDF was replaced with the copolymer formed by 85% VDF, 10% pentafluoropropylene, and 5% hexafluorobutadiene.

### Example 8

Example 8 was the same as Example 1 except that in <Preparation of binder>, the binder PVDF was replaced with the copolymer formed by 90% VDF and 10% trifluoroethylene.

### Example 9

Example 9 was the same as Example 1 except that in <Preparation of binder>, the binder PVDF was replaced with the copolymer formed by 85% VDF, 10% perfluorobutene, and 5% tetrafluoroethylene.

### Example 10

Example 10 was the same as Example 1 except that in <Preparation of binder>, the reaction time was adjusted to 2 h, such that the binder had no diffraction peak C at 42.2°.

### Example 11

Example 11 was the same as Example 2 except that in <Preparation of binder>, the weight-average molecular weight of the binder was adjusted to 800000.

### Example 12

Example 12 was the same as Example 2 except that in <Preparation of binder>, the weight-average molecular weight of the binder was adjusted to 950000.

### Example 13

Example 13 was the same as Example 2 except that in <Preparation of binder>, the weight-average molecular weight of the binder was adjusted to 1100000.

### Example 14

Example 14 was the same as Example 2 except that in <Preparation of binder>, the molecular weight distribution of the binder was adjusted to satisfy Mw/Mn=2.05.

### Example 15

Example 15 was the same as Example 2 except that in <Preparation of binder>, the molecular weight distribution of the binder was adjusted to satisfy Mw/Mn=2.8.

### Example 16

Example 16 was the same as Example 2 except that in <Preparation of binder>, the molecular weight distribution of the binder was adjusted to satisfy Mw/Mn=3.2.

### Example 17

Example 17 was the same as Example 2 except that in <Preparation of binder>, the molecular weight distribution of the binder was adjusted to satisfy Mw/Mn=3.6.

### Example 18

Example 18 was the same as Example 2 except that in <Preparation of positive electrode plate>, Dᵥ50 of the positive electrode active substance was adjusted to 0.5 μm.

### Example 19

Example 19 was the same as Example 2 except that in <Preparation of positive electrode plate>, Dᵥ50 of the positive electrode active substance was adjusted to 10 μm.

### Example 20

Example 20 was the same as Example 2 except that in <Preparation of positive electrode plate>, Dᵥ50 of the positive electrode active substance was adjusted to 20 μm.

### Example 21

Example 21 was the same as Example 2 except that in <Preparation of positive electrode plate>, Dᵥ50 of the positive electrode active substance was adjusted to 35 μm.

### Example 22

Example 22 was the same as Example 2 except that in <Preparation of positive electrode plate>, the single-sided thickness of the positive electrode mixture layer was adjusted to 40.5 μm.

### Example 23

Example 23 was the same as Example 2 except that in <Preparation of positive electrode plate>, the single-sided thickness of the positive electrode mixture layer was adjusted to 45 μm.

### Example 24

Example 24 was the same as Example 2 except that in <Preparation of positive electrode plate>, the single-sided thickness of the positive electrode mixture layer was adjusted to 50 μm.

### Example 25

Example 25 was the same as Example 2 except that in <Preparation of positive electrode plate>, the single-sided thickness of the positive electrode mixture layer was adjusted to 55 μm.

### Example 26

Example 26 was the same as Example 2 except that in <Preparation of positive electrode plate>, the thickness of the positive electrode current collector was adjusted to 7 μm.

### Example 27

Example 27 was the same as Example 2 except that in <Preparation of positive electrode plate>, the thickness of the positive electrode current collector was adjusted to 10 μm.

### Example 28

Example 28 was the same as Example 2 except that in <Preparation of positive electrode plate>, the thickness of the positive electrode current collector was adjusted to 20 μm.

### Example 29

Example 29 was the same as Example 2 except that in <Preparation of binder>, the weight-average molecular weight of the binder was adjusted to 1200000.

### Example 30

Example 30 was the same as Example 2 except that in <Preparation of binder>, the weight-average molecular weight of the binder was adjusted to 700000.

### Example 31

Example 31 was the same as Example 2 except that in <Preparation of binder>, the molecular weight distribution of the binder was adjusted to satisfy Mw/Mn=2.00.

### Example 32

Example 32 was the same as Example 2 except that in <Preparation of binder>, the molecular weight distribution of the binder was adjusted to satisfy Mw/Mn=3.70.

### Example 33

Example 33 was the same as Example 2 except that in <Preparation of positive electrode plate>, Dᵥ50 of the positive electrode active substance was adjusted to 0.2 μm.

### Example 34

Example 34 was the same as Example 2 except that in <Preparation of positive electrode plate>, Dᵥ50 of the positive electrode active substance was adjusted to 38 μm.

### Example 35

Example 35 was the same as Example 2 except that in <Preparation of positive electrode plate>, the single-sided thickness of the positive electrode mixture layer was adjusted to 40 μm.

### Example 36

Example 36 was the same as Example 2 except that in <Preparation of positive electrode plate>, the single-sided thickness of the positive electrode mixture layer was adjusted to 56 μm.

### Example 37

Example 37 was the same as Example 2 except that in <Preparation of positive electrode plate>, the thickness of the positive electrode current collector was adjusted to 6 μm.

### Example 38

Example 38 was the same as Example 2 except that in <Preparation of positive electrode plate>, the thickness of the positive electrode current collector was adjusted to 22 μm.

### Comparative Example 1

Comparative Example 1 was the same as Example 1 except that in <Preparation of binder>, the PVDF-HFP (Wu Yu, #W7500) polymer was used as the binder.

### Comparative Example 2

Comparative Example 2 was the same as Example 1 except that in <Preparation of binder>, the polyimide (PI) was used as the binder.

### Comparative Example 3

Comparative Example 3 was the same as Example 1 except that in <Preparation of binder>, the PVDF—COOH (Solvay S.A., 5130) polymer was used as the binder.

### Comparative Example 4

Comparative Example 4 was the same as Example 1 except that in <Preparation of binder>, the reaction temperature was adjusted to 95° C. and the reaction time was adjusted to 2 h, such that the binder had no diffraction peak C at 42.2° and the area ratio of the diffraction peak A to the diffraction peak B satisfied A(111)/B(022)=5.05.

### Comparative Example 5

Comparative Example 5 was the same as Example 1 except that in <Preparation of binder>, the reaction temperature was adjusted to 95° C., such that the area ratio of the diffraction peak A to the diffraction peak B of the binder satisfied A(111)/B(022)=5.05.

### Comparative Example 6

Comparative Example 6 was the same as Example 1 except that in <Preparation of binder>, the reaction temperature was adjusted to 85° C., such that the area ratio of the diffraction peak A to the diffraction peak B of the binder satisfied A(111)/B(022)=0.55.

The preparation parameters and test results of the examples and comparative examples are shown in Table 1 and Table 2 below.

TABLE 1

| | | | | | | Adhesion | | | | |
|---|---|---|---|---|---|---|---|---|---|---|
| | | | | | | force | | | | |
| | | | | | | between | | | | |
| | | | | | | positive | | | | |
| | | | | | | electrode | | | | |
| | | | | | | mixture | | | | |
| | | (111) | (022) | | (131) | layer | | | | |
| | | diffraction | diffraction | | diffraction | and | Ultimate | | Thickness | Capacity |
| | Material | peak | peak | | peak | current | compacted | | swelling | retention |
| | of | A at | B at | A(111)/ | C at | collector | density | Brittle | rate | rate |
| | binder | 26.2° | 38.5° | B(022) | 42.2° | (N/m) | (g/mm³) | fracture | (%) | (%) |
| Example 1 | PVDF | Found | Found | 1.0 | Found | 18.4 | 4.33 | None | 8.20 | 84.30 |
| Example 2 | PVDF | Found | Found | 1.5 | Found | 18.6 | 4.34 | None | 7.80 | 86.30 |
| Example 3 | PVDF | Found | Found | 2.4 | Found | 17.9 | 4.34 | None | 7.90 | 84.90 |
| Example 4 | PVDF | Found | Found | 3.2 | Found | 18.4 | 4.32 | None | 8.60 | 83.90 |
| Example 5 | PVDF | Found | Found | 3.9 | Found | 18.2 | 4.31 | None | 8.90 | 82.90 |
| Example 6 | Copolymer formed by | Found | Found | 1.8 | Found | 17.8 | 4.23 | None | 9.80 | 80.90 |
| | 95% VDF and | | | | | | | | | |
| | 5% hexafluoropropylene | | | | | | | | | |
| Example 7 | Copolymer formed by | Found | Found | 2.2 | Found | 18.2 | 4.23 | None | 10.20 | 81.90 |
| | 85% VDF, | | | | | | | | | |
| | 10% pentafluoropropylene, | | | | | | | | | |
| | and | | | | | | | | | |
| | 5% hexafluorobutadiene | | | | | | | | | |
| Example 8 | 90% VDF and | Found | Found | 1.8 | Found | 18.0 | 4.23 | None | 9.70 | 81.20 |
| | 10% trifluoroethylene | | | | | | | | | |
| Example 9 | Copolymer formed by | Found | Found | 2.1 | Found | 18.3 | 4.23 | None | 10.10 | 81.50 |
| | 85% VDF, | | | | | | | | | |
| | 10% perfluorobutene, | | | | | | | | | |
| | and | | | | | | | | | |
| | 5% tetrafluoroethylene | | | | | | | | | |
| Example 10 | PVDF | Found | Found | 1.0 | None | 16.3 | 4.21 | Slight | 10.30 | 78.80 |
| Comparative | PVDF-HFP | Found | None | — | None | 14.2 | 4.21 | Severe | 15.80 | 72.80 |
| Example 1 | | | | | | | | | | |
| Comparative | PI | None | None | — | None | 8.8 | 4.05 | Severe | 22.50 | 50.60 |
| Example 2 | | | | | | | | | | |
| Comparative | PVDF-COOH | None | Found | — | None | 10.8 | 3.95 | Severe | 17.80 | 68.30 |
| Example 3 | | | | | | | | | | |
| Comparative | PVDF | Found | Found | 5.05 | None | 19.8 | 4.24 | Severe | 13.60 | 73.50 |
| Example 4 | | | | | | | | | | |
| Comparative | PVDF | Found | Found | 5.05 | Found | 17.3 | 4.29 | Severe | 12.80 | 72.60 |
| Example 5 | | | | | | | | | | |
| Comparative | PVDF | Found | Found | 0.55 | Found | 17.4 | 4.27 | Slight | 13.30 | 74.90 |
| Example 6 | | | | | | | | | | |

In Table 1, “—” means not detected.

TABLE 2

| | | | | | | | | Single- |
|---|---|---|---|---|---|---|---|---|
| | | | | | | | | sided |
| | | | | | Weight- | | Dᵥ50 | thickness |
| | | | | | average | | of | of |
| | | (111) | (022) | | molecular | | positive | positive |
| | | diffraction | diffraction | | weight | | electrode | electrode |
| | Material | peak | peak | | of | | active | mixture |
| | of | A at | B at | A(111)/ | binder | | substance | layer |
| | binder | 26.2° | 38.5° | B(022) | (10⁴) | Mw/Mn | (μm) | (μm) |
| Example | PVDF | Found | Found | 1.5 | 80 | 2.18 | 15.6 | 46 |
| 11 | | | | | | | | |
| Example | PVDF | Found | Found | 1.5 | 95 | 2.18 | 15.6 | 46 |
| 12 | | | | | | | | |
| Example | PVDF | Found | Found | 1.5 | 110 | 2.18 | 15.6 | 46 |
| 13 | | | | | | | | |
| Example | PVDF | Found | Found | 1.5 | 90 | 2.05 | 15.6 | 46 |
| 14 | | | | | | | | |
| Example | PVDF | Found | Found | 1.5 | 90 | 2.8 | 15.6 | 46 |
| 15 | | | | | | | | |
| Example | PVDF | Found | Found | 1.5 | 90 | 3.2 | 15.6 | 46 |
| 16 | | | | | | | | |
| Example | PVDF | Found | Found | 1.5 | 90 | 3.6 | 15.6 | 46 |
| 17 | | | | | | | | |
| Example | PVDF | Found | Found | 1.5 | 90 | 2.18 | 0.5 | 46 |
| 18 | | | | | | | | |
| Example | PVDF | Found | Found | 1.5 | 90 | 2.18 | 10 | 46 |
| 19 | | | | | | | | |
| Example | PVDF | Found | Found | 1.5 | 90 | 2.18 | 20 | 46 |
| 20 | | | | | | | | |
| Example | PVDF | Found | Found | 1.5 | 90 | 2.18 | 35 | 46 |
| 21 | | | | | | | | |
| Example | PVDF | Found | Found | 1.5 | 90 | 2.18 | 15.6 | 40.5 |
| 22 | | | | | | | | |
| Example | PVDF | Found | Found | 1.5 | 90 | 2.18 | 15.6 | 45 |
| 23 | | | | | | | | |
| Example | PVDF | Found | Found | 1.5 | 90 | 2.18 | 15.6 | 50 |
| 24 | | | | | | | | |
| Example | PVDF | Found | Found | 1.5 | 90 | 2.18 | 15.6 | 55 |
| 25 | | | | | | | | |
| Example | PVDF | Found | Found | 1.5 | 90 | 2.18 | 15.6 | 46 |
| 26 | | | | | | | | |
| Example | PVDF | Found | Found | 1.5 | 90 | 2.18 | 15.6 | 46 |
| 27 | | | | | | | | |
| Example | PVDF | Found | Found | 1.5 | 90 | 2.18 | 15.6 | 46 |
| 28 | | | | | | | | |
| Example | PVDF | Found | Found | 1.5 | 120 | 2.18 | 15.6 | 46 |
| 29 | | | | | | | | |
| Example | PVDF | Found | Found | 1.5 | 70 | 2.18 | 15.6 | 46 |
| 30 | | | | | | | | |
| Example | PVDF | Found | Found | 1.5 | 90 | 2.00 | 15.6 | 46 |
| 31 | | | | | | | | |
| Example | PVDF | Found | Found | 1.5 | 90 | 3.70 | 15.6 | 46 |
| 32 | | | | | | | | |
| Example | PVDF | Found | Found | 1.5 | 90 | 2.18 | 0.2 | 46 |
| 33 | | | | | | | | |
| Example | PVDF | Found | Found | 1.5 | 90 | 2.18 | 38 | 46 |
| 34 | | | | | | | | |
| Example | PVDF | Found | Found | 1.5 | 90 | 2.18 | 15.6 | 40 |
| 35 | | | | | | | | |
| Example | PVDF | Found | Found | 1.5 | 90 | 2.18 | 15.6 | 56 |
| 36 | | | | | | | | |
| Example | PVDF | Found | Found | 1.5 | 90 | 2.18 | 15.6 | 46 |
| 37 | | | | | | | | |
| Example | PVDF | Found | Found | 1.5 | 90 | 2.18 | 15.6 | 46 |
| 38 | | | | | | | | |

| | | | Adhesion | | | |
|---|---|---|---|---|---|---|
| | | | force | | | |
| | | | between | | | |
| | Thickness | | positive | | | |
| | of | | electrode | | | |
| | positive | | mixture | | | |
| | electrode | Ultimate | layer and | | Thickness | Capacity |
| | current | compacted | current | | swelling | retention |
| | collector | density | collector | Brittle | rate | rate |
| | (μm) | (g/mm³) | (N/m) | fracture | (%) | (%) |
| Example | 9 | 4.33 | 17.3 | None | 8.30 | 85.20 |
| 11 | | | | | | |
| Example | 9 | 4.34 | 18.6 | None | 7.80 | 86.30 |
| 12 | | | | | | |
| Example | 9 | 4.34 | 18.9 | None | 7.90 | 85.30 |
| 13 | | | | | | |
| Example | 9 | 4.32 | 18.5 | None | 8.30 | 83.30 |
| 14 | | | | | | |
| Example | 9 | 4.33 | 17.4 | None | 8.00 | 82.30 |
| 15 | | | | | | |
| Example | 9 | 4.32 | 16.5 | None | 8.20 | 82.1 |
| 16 | | | | | | |
| Example | 9 | 4.34 | 15.8 | None | 8.50 | 81.60 |
| 17 | | | | | | |
| Example | 9 | 3.9 | 11.3 | None | 9.50 | 80.30 |
| 18 | | | | | | |
| Example | 9 | 4.15 | 13.4 | None | 9.20 | 81.90 |
| 19 | | | | | | |
| Example | 9 | 4.22 | 15.7 | None | 10.30 | 82.50 |
| 20 | | | | | | |
| Example | 9 | 4.13 | 16.5 | None | 12.50 | 79.70 |
| 21 | | | | | | |
| Example | 9 | 4.28 | 13.5 | None | 8.50 | 81.30 |
| 22 | | | | | | |
| Example | 9 | 4.31 | 18.2 | None | 8.30 | 85.50 |
| 23 | | | | | | |
| Example | 9 | 4.26 | 17.6 | None | 9.60 | 85.30 |
| 24 | | | | | | |
| Example | 9 | 4.23 | 16.8 | None | 9.90 | 83.20 |
| 25 | | | | | | |
| Example | 7 | 4.25 | 15.8 | None | 8.20 | 84.30 |
| 26 | | | | | | |
| Example | 10 | 4.35 | 17.9 | None | 8.30 | 82.90 |
| 27 | | | | | | |
| Example | 20 | 4.31 | 16.5 | None | 8.10 | 83.70 |
| 28 | | | | | | |
| Example | 9 | 4.29 | 19.3 | None | 9.70 | 80.80 |
| 29 | | | | | | |
| Example | 9 | 4.32 | 16.2 | None | 8.80 | 84.30 |
| 30 | | | | | | |
| Example | 9 | 4.15 | 15.5 | None | 9.80 | 77.80 |
| 31 | | | | | | |
| Example | 9 | 4.16 | 15.3 | None | 11.30 | 78.50 |
| 32 | | | | | | |
| Example | 9 | 3.85 | 10.3 | Slight | 10.40 | 78.30 |
| 33 | | | | | | |
| Example | 9 | 4.05 | 10.3 | Slight | 15.60 | 78.80 |
| 34 | | | | | | |
| Example | 9 | 4.21 | 12.3 | None | 8.80 | 81.80 |
| 35 | | | | | | |
| Example | 9 | 4.18 | 11.9 | None | 10.90 | 79.50 |
| 36 | | | | | | |
| Example | 6 | 4.05 | 13.2 | Slight | 8.80 | 79.90 |
| 37 | | | | | | |
| Example | 22 | 4.25 | 16.2 | None | 8.30 | 80.30 |
| 38 | | | | | | |

It can be learned from Examples 1 to 10 and Comparative Examples 1 to 6 that when the binder has the (111) diffraction peak A at 26.2° and the (022) diffraction peak B at 38.5° and A(111)/B(022) is within the range of this application, the positive electrode plate of this application has a high ultimate compacted density, alleviating the brittle fracture of the positive electrode plate, and improving the anti-swelling performance and cycling performance of the lithium-ion battery.

It can be learned from Example 1 and Example 10 that when the binder has the (131) diffraction peak C at 42.2°, the ultimate compacted density of the positive electrode plate can be further increased, and the anti-swelling performance and cycling performance of the lithium-ion battery can be further improved.

It can be learned from Examples 11 to 13 and Examples 29 and 30 that the weight-average molecular weight of the binder being controlled within the range of this application can further increase the ultimate compacted density of the positive electrode plate and improve the anti-swelling performance and cycling performance of the lithium-ion battery.

It can be learned from Examples 14 to 17 and Examples 31 and 32 that the molecular weight distribution Mw/Mn of the binder being controlled within the range of this application can further increase the ultimate compacted density of the positive electrode plate, enhance the adhesion between the positive electrode mixture layer and the current collector, and improve the anti-swelling performance and cycling performance of the lithium-ion battery.

It can be learned from Examples 18 to 21 and Examples 33 and 34 that Dᵥ50 of the positive electrode active substance being controlled within the range of this application can further increase the ultimate compacted density of the positive electrode plate, alleviate the brittle fracture of the positive electrode plate, enhance the adhesion between the positive electrode mixture layer and the current collector, and improve the anti-swelling performance and cycling performance of the lithium-ion battery.

It can be learned from Examples 22 to 25 and Examples 35 and 36 that the single-sided thickness of the positive electrode mixture layer being controlled within the range of this application can further increase the ultimate compacted density of the positive electrode plate, enhance the adhesion between the positive electrode mixture layer and the current collector, and improve the cycling performance of the lithium-ion battery.

It can be learned from Examples 26 to 28 and Examples 37 and 38 that the thickness of the positive electrode current collector being controlled within the range of this application can further increase the ultimate compacted density of the positive electrode plate, alleviate the brittle fracture of the positive electrode plate, and improve the anti-swelling performance and cycling performance of the lithium-ion battery.

The foregoing descriptions are merely preferred embodiments of this application, and are not intended to limit this application. Any modifications, equivalent replacements, improvements, and the like made without departing from the spirit and principle of this application shall fall within the protection scope of this application.

What is claimed is:

1. An electrochemical apparatus, comprising a positive electrode, wherein the positive electrode comprises a current collector and a positive electrode mixture layer disposed on at least one surface of the current collector; and the positive electrode mixture layer comprises a positive electrode active substance and a binder; wherein
the binder comprises a fluorine-containing polymer, and in an XRD diffraction pattern of the fluorine-containing polymer, a diffraction peak A appears at 25° to 27° and corresponds to a (111) crystal plane, and a diffraction peak B appears at 37° to 39° and corresponds to a (022) crystal plane, wherein 1≤A(111)/B(022)≤4,
A(111) is an area of the diffraction peak A and B(022) is an area of the diffraction peak B.

2. The electrochemical apparatus according to claim 1, wherein in the XRD diffraction pattern of the fluorine-containing polymer, a diffraction peak C appears at 42° to 43° and corresponds to a (131) crystal plane.

3. The electrochemical apparatus according to claim 1, wherein a weight-average molecular weight of the binder is 800000 to 1100000.

4. The electrochemical apparatus according to claim 1, wherein a molecular weight distribution of the binder satisfies:
2.05≤Mw/Mn≤3.6, wherein Mn is a number-average molecular weight of the binder, and Mw is a weight-average molecular weight of the binder.

5. The electrochemical apparatus according to claim 1, wherein the fluorine-containing polymer comprises at least one selected from the group consisting of homopolymers or copolymers of vinylidene fluoride, hexafluoropropylene, pentafluoropropylene, tetrafluoropropylene, trifluoropropylene, perfluorobutene, hexafluorobutadiene, hexafluoroisobutylene, trifluoroethylene, trifluorochloroethylene, and tetrafluoroethylene.

6. The electrochemical apparatus according to claim 1, wherein an ultimate compacted density of the positive electrode mixture layer is 3.0 g/mm³ to 4.5 g/mm³.

7. The electrochemical apparatus according to claim 1, wherein an adhesion force between the positive electrode mixture layer and the current collector is 15 N/m to 35 N/m.

8. The electrochemical apparatus according to claim 1, wherein a Dᵥ50 of the positive electrode active substance is 0.5 μm to 35 μm.

9. The electrochemical apparatus according to claim 1, wherein a thickness of the current collector is 7 μm to 20 μm.

10. The electrochemical apparatus according to claim 1, wherein the positive electrode satisfies at least one of the following characteristics:
(a) a compacted density of the positive electrode mixture layer is 4.1 g/mm³ to 4.4 g/mm³;
(b) a Dᵥ50 of the positive electrode active substance is 10 μm to 25 μm;
(c) a single-sided thickness of the positive electrode mixture layer is 40.5 μm to 55 μm;
(d) a thickness of the current collector is 8 μm to 12 μm; or
(e) a mass percentage of the binder in the positive electrode mixture layer is 1% to 5%.

11. An electronic apparatus, comprising an electrochemical apparatus, the electrochemical apparatus comprises a positive electrode, wherein the positive electrode comprises a current collector and a positive electrode mixture layer disposed on at least one surface of the current collector; and the positive electrode mixture layer comprises a positive electrode active substance and a binder; wherein
the binder comprises a fluorine-containing polymer, and in an XRD diffraction pattern of the fluorine-containing polymer, a diffraction peak A appears at 25° to 27° and corresponds to a (111) crystal plane, and a diffraction peak B appears at 37° to 39° and corresponds to a (022) crystal plane, wherein 1≤A(111)/B(022)≤4,
A(111) is an area of the diffraction peak A and B(022) is an area of the diffraction peak B.

12. The electronic apparatus according to claim 11, wherein in the XRD diffraction pattern of the fluorine-containing polymer, a diffraction peak C appears at 42° to 43° and corresponds to a (131) crystal plane.

13. The electronic apparatus according to claim 11, wherein a weight-average molecular weight of the binder is 800000 to 1100000.

14. The electronic apparatus according to claim 11, wherein a molecular weight distribution of the binder satisfies:
2.05≤Mw/Mn≤3.6, wherein Mn is a number-average molecular weight of the binder, and Mw is a weight-average molecular weight of the binder.

15. The electronic apparatus according to claim 11, wherein the fluorine-containing polymer comprises at least one selected from the group consisting of homopolymers or copolymers of vinylidene fluoride, hexafluoropropylene, pentafluoropropylene, tetrafluoropropylene, trifluoropropylene, perfluorobutene, hexafluorobutadiene, hexafluoroisobutylene, trifluoroethylene, trifluorochloroethylene, and tetrafluoroethylene.

16. The electronic apparatus according to claim 11, wherein an ultimate compacted density of the positive electrode mixture layer is 3.0 g/mm³ to 4.5 g/mm³.

17. The electronic apparatus according to claim 11, wherein an adhesion force between the positive electrode mixture layer and the current collector is 15 N/m to 35 N/m.

18. The electronic apparatus according to claim 11, wherein a Dᵥ50 of the positive electrode active substance is 0.5 μm to 35 μm.

19. The electronic apparatus according to claim 11, wherein a thickness of the current collector is 7 μm to 20 μm.

20. The electronic apparatus according to claim 11, wherein the positive electrode satisfies at least one of the following characteristics:
(a) a compacted density of the positive electrode mixture layer is 4.1 g/mm³ to 4.4 g/mm³;
(b) a Dᵥ50 of the positive electrode active substance is 10 μm to 25 μm;
(c) a single-sided thickness of the positive electrode mixture layer is 40.5 μm to 55 μm;
(d) a thickness of the current collector is 8 μm to 12 μm; or
(e) a mass percentage of the binder in the positive electrode mixture layer is 1% to 5%.
